(19) United States
(12) Patent Application Publication
(10) Pub. No.: US 2021/0220858 A1
(43) Pub. Date: Jul. 22, 2021

(54) SPRAYER ACCESSORY HOLDER

(71) Applicant: Keutzer Design and Consulting, LLC, Jasper, MO (US)

(72) Inventor: Chad T. Keutzer, Jasper, MO (US)

(21) Appl. No.: 16/747,230

(22) Filed: Jan. 20, 2020

(51) Int. Cl. B05B 15/60; F16M 13/02

(52) U.S. Cl. CPC B05B 15/60; F16M 13/02

(57) ABSTRACT

A sprayer accessory holder provides a place to put multiple tip housings and multiple spray tip nozzles. The sprayer accessory holder can be a separate piece that is attached to an airless sprayer, can be part of a replacement part for an airless sprayer, or can be part of a new part on an airless sprayer. The sprayer accessory holder preferably includes a plurality of retaining members, one or more of which is dimensioned to receive a tip housing and one or more of which is dimensioned to receive a spray tip nozzle. Each retaining member can have external dimensions to receive a tip housing and a substantially hollow interior with an opening dimensioned to receive a spray tip nozzle, allowing a user to use each retaining member for a tip housing or a spray tip nozzle at the user's discretion.

### BACKGROUND

### 1. Technical Field

This disclosure generally relates to sprayers, and more specifically relates to paint sprayers.

### 2. Background Art

Paint sprayers are used in many applications. Some paint sprayers dispense paint from a small reservoir in a handheld spray gun using compressed air. Airless paint sprayers are often used in residential and commercial painting. An airless paint sprayer pumps paint from a can or bucket close to the paint sprayer through a hose to a handheld spray gun, which allows a person to paint a large area without having to stop and refill a small reservoir on a handheld spray gun, as would normally be required with a paint sprayer that uses compressed air.

Various nozzles can be used on an airless paint sprayer depending on the application and the spray pattern that is desired. Changing nozzles on an airless paint sprayer typically involves locating the new nozzle that is needed, such as in a toolbox, removing the old nozzle by unscrewing the old nozzle from the spray gun, and screwing the new nozzle in place. The painter must then put the old nozzle that was removed in a suitable storage place, such as a toolbox.

### BRIEF SUMMARY

A sprayer accessory holder provides a place to put multiple tip housings and multiple spray tip nozzles. The sprayer accessory holder can be a separate piece that is attached to an airless sprayer, can be part of a replacement part for an airless sprayer, or can be part of a new part on an airless sprayer. The sprayer accessory holder preferably includes a plurality of retaining members, one or more of which is dimensioned to receive a tip housing and one or more of which is dimensioned to receive a spray tip nozzle. In one suitable embodiment, each retaining member has external dimensions for receiving a tip housing and a substantially hollow interior with an opening dimensioned to receive a spray tip nozzle. This allows a user to use any retaining member to hold a tip housing or to hold a spray tip nozzle, at the user's discretion. The sprayer accessory holder can optionally include a holder for a wire brush. The sprayer accessory holder provides a place to store and access tip housings and spray tip nozzles on the airless sprayer, thereby eliminating the need to retrieve these parts from a toolbox or to return these parts to a toolbox.

The foregoing and other features and advantages will be apparent from the following more particular description, as illustrated in the accompanying drawings.

### BRIEF DESCRIPTION OF THE SEVERAL VIEWS OF THE DRAWING(S)

The disclosure will be described in conjunction with the appended drawings, where like designations denote like elements, and:

FIG. 1 is an upper perspective view of a sprayer accessory holder;

FIG. 2 is a top view of the sprayer accessory holder shown in FIG. 1;

FIG. 3 is a top view of a tip housing;

FIG. 4 is a side view of the tip housing shown in FIG. 3;

FIG. 5 is a side view of a spray tip nozzle;

FIG. 6 is a top view of the sprayer accessory holder shown in FIGS. 1 and 2 with a tip housing installed on one of the retaining members and a spray tip nozzle installed on another of the retaining members;

FIG. 7 is a side view of one specific embodiment for a retaining member for holding a tip housing;

FIG. 8 is a side view of one specific embodiment for a retaining member for holding a spray tip nozzle;

FIG. 9 is a side view of one specific embodiment for a retaining member that is a separate piece that can be attached to a base plate;

FIG. 10 is a side view of a retaining member showing external threads;

FIG. 11 is a side view of a retaining member showing external ridges;

FIG. 12 is a side view of a retaining member showing external bumps;

FIG. 13 is top view of a sprayer accessory holder showing slots for straps that attach the sprayer accessory holder to an airless sprayer;

FIG. 14 is a perspective view of an airless sprayer;

FIG. 15 is flow diagram of a first method for providing a sprayer accessory holder on an airless sprayer;

FIG. 16 is flow diagram of a second method for providing a sprayer accessory holder on an airless sprayer;

FIG. 17 is flow diagram of a third method for providing a sprayer accessory holder on an airless sprayer;

FIG. 18 is flow diagram of a fourth method for providing a sprayer accessory holder on an airless sprayer;

FIG. 19 is an embodiment for the sprayer accessory holder that uses a single type of retaining member;

FIG. 20 is a side view of the retaining members shown in FIG. 19;

FIG. 21 is an upper perspective view of a large sprayer accessory holder;

FIG. 22 is a top view of one specific configuration for a retaining member;

FIG. 23 is a top view of one specific configuration for a retaining member;

FIG. 24 is a side view of one specific configuration for a retaining member;

FIG. 25 is a top view of one specific configuration for a retaining member;

FIG. 26 is a top view of one specific configuration for a retaining member;

FIG. 27 is a top view of one specific configuration for a retaining member;

FIG. 28 is a side view of one specific configuration for a retaining member;

FIG. 29 is a side view of one specific configuration for a retaining member;

FIG. 30 is a side view of one specific configuration for a retaining member;

FIG. 31 is a top view of one specific configuration for a retaining member;

FIG. 32 is a top view of one specific configuration for a retaining member;

FIG. 33 is a side view of one specific configuration for a retaining member;

FIG. 34 is a top view of one specific configuration for a top hole for a retaining member;

FIG. 35 is a top view of one specific configuration for a top hole for a retaining member;

FIG. 36 is a top view of one specific configuration for a top hole for a retaining member;

FIG. 37 is a top view of one specific configuration for a top hole for a retaining member;

FIG. 38 is a top view of one specific configuration for a top hole for a retaining member;

FIG. 39 is a top view of one specific configuration for a top hole for a retaining member;

FIG. 40 is a top view of one specific configuration for a top hole for a retaining member; and

FIG. 41 is a side view of one specific configuration for a retaining member.

### DETAILED DESCRIPTION

A sprayer accessory holder provides a place to put multiple tip housings and multiple spray tip nozzles. The sprayer accessory holder can be a separate piece that is attached to an airless sprayer, can be part of a replacement part for an airless sprayer, or can be part of a new part on an airless sprayer. The sprayer accessory holder preferably includes a plurality of retaining members. In a first embodiment, one or more of the retaining members has exterior dimensions to receive a tip housing and one or more of the retaining members has interior dimensions to receive a spray tip nozzle. In a second embodiment, all of the retaining members have exterior dimensions to receive a tip housing and interior dimensions to receive a spray tip nozzle. In one suitable implementation, the retaining members in the first and second embodiments are frustoconical members. The sprayer accessory holder can optionally include a holder for a wire brush. The sprayer accessory holder provides a place to store and access tip housings and spray tip nozzles on the airless sprayer, thereby eliminating the need to retrieve these parts from a toolbox or to return these parts to a toolbox.

The terminology for parts used on airless sprayers varies. Airless spray guns typically have two parts at the tip of the spray gun that control the spraying of paint. The first is a housing that is screwed onto the tip of the spray gun. The second is a cylindrical piece with a hole. The cylindrical piece is inserted into the housing, and the hole is aligned with a corresponding hole in the housing, allowing paint to pass into the housing, through the hole in the cylindrical piece, and out of the housing onto a surface being painted. When a clog occurs, the cylindrical piece can be rotated 180 degrees in the housing, which causes paint to pass through the hole in the opposite direction, clearing the clog. There are various different names for the housing that are known in the art, including guard, spray tip guard and tip housing. Similarly, there are various different names of the cylindrical piece with a hole, including spray gun tip, spray tip, tip, spray tip nozzle, and spray gun nozzle. In some contexts, even these known labels can mean different things. For example, the term “spray gun tip” or “tip” can mean the cylindrical piece by itself, or can mean the cylindrical piece with the housing. Sometimes the two pieces combined are called a tip and guard combo. For the discussion herein, the housing that is screwed onto the spray gun is referred to as a “tip housing”, and the cylindrical piece with a hole that is inserted into the tip housing is referred to as a “spray tip nozzle.”

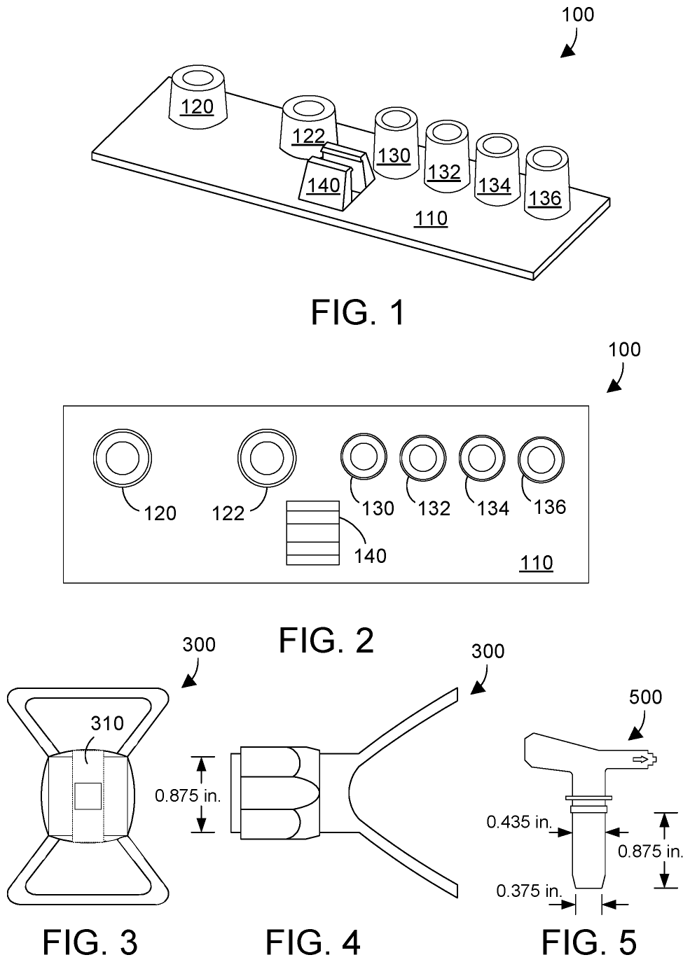

FIG. 1 shows a perspective view of a first suitable embodiment for a sprayer accessory holder 100, and FIG. 2 shows a top view of the sprayer accessory holder 100 in FIG. 1. The sprayer accessory holder 100 includes a base plate 110, a plurality of frustoconical retaining members 120, 122, 130, 132, 134 and 136 fixedly coupled to the based plate 110, and a brush holder 140 fixedly coupled to the base plate. The retaining members 120 and 122 preferably have a first base diameter, and the retaining members 130, 132, 134 and 136 preferably have a second base diameter less than the first base diameter of the retaining members 120 and 122. Similarly, the retaining members 120 and 122 preferably have a first top diameter, and the retaining members 130, 132, 134 and 136 preferably have a second top diameter less than the first top diameter of the retaining members 120 and 122. Stated more simply, the retaining members 130, 132, 134 and 136 are cone frustums that are smaller in diameter than the cone frustums of retaining members 120 and 122, although the retaining members 130, 132, 134 and 136 have a greater height than the retaining members 120, 122. The retaining members 120 and 122 preferably haver exterior dimensions so the external surface can engage internal threads on a tip housing, thereby keeping the tip housing in place on the retaining members 120 and 122. The retaining members 130, 132, 134 and 136 each include a substantially hollow interior that is preferably dimensioned to receive a portion of a substantially cylindrical body of a spray tip nozzle. The retaining members 120 and 122 are shown in FIG. 1 to also have a substantially hollow interior, but the retaining members 120 and 122 are not required to have a substantially hollow interior. The brush holder 140 is preferably dimensioned to receive and hold in place the handle on a suitable brush, such as a wire brush. A painter often uses a wire brush to brush away paint on tip housings and spray tip nozzles.

FIG. 3 shows a top view of a tip housing 300. The tip housing 300 preferably includes a substantially cylindrical passage 310 into which the substantially cylindrical body of a spray tip nozzle can be inserted and rotated. FIG. 4 shows a side view of the tip housing 300 shown in FIG. 3. Tip housing 300 is most preferably a well-known tip housing on many airless paint sprayers, many of which have 0.875 in (22 mm) coarse internal threads that mate with corresponding external threads on the spray gun. A prior art spray tip nozzle 500 is shown in FIG. 5, with the dimensions as shown. Spray tip nozzle 500 is most preferably a well-known spray tip nozzle used on many airless paint sprayers that has a substantially cylindrical body with a hole (not shown in FIG. 5), and with dimensions as shown.

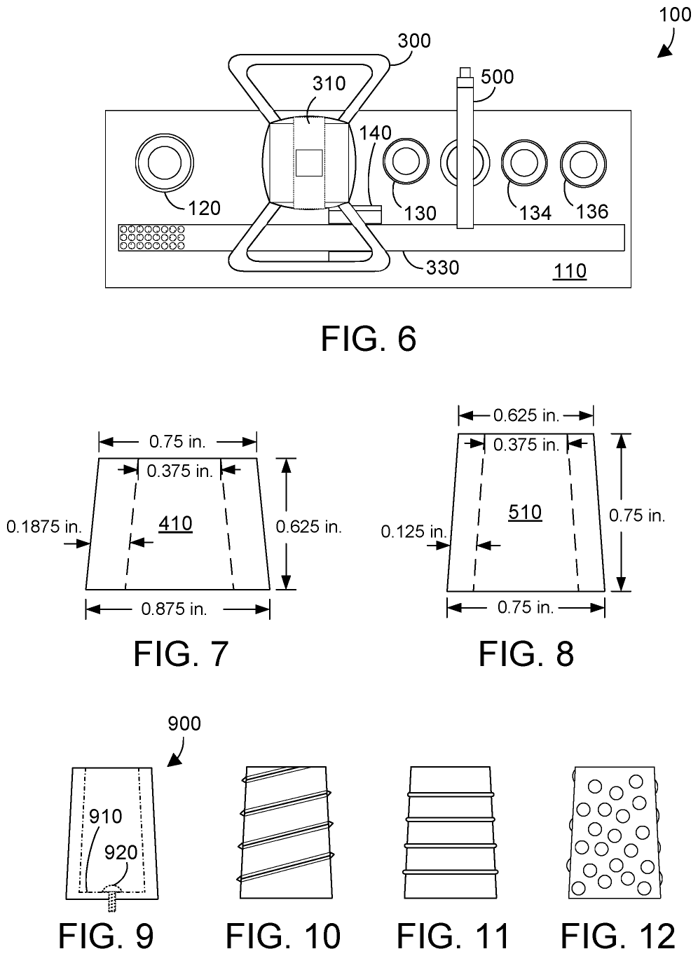

FIG. 6 shows the sprayer accessory holder 100 in FIGS. 1 and 2 with a tip housing 300 installed on the retaining member 122 (not visible in FIG. 3), with a spray tip nozzle 500 installed in the retaining member 132 (not visible in FIG. 3), and with a wire brush 330 installed in the brush holder 140. The tip housing 300 is installed in the retaining member 122 by either pressing the spray tip nozzle onto the retaining member 122, or more preferably by twisting the tip housing 300 on the retaining member 122 so the internal threads on the tip housing 300 engage the exterior surface of the retaining member 122. A handle for spray tip nozzle 500 is shown in FIG. 6, and allows the spray tip nozzle to be rotated 180 degrees when installed in the tip housing 300 to spray out a clog in the spray tip nozzle, as is well-known in the art. The spray tip nozzle 500 is installed in retaining member 132 by pushing the substantially cylindrical portion of the spray tip nozzle 500 into the substantially hollow interior portion of the retaining member 132. The interior dimension of the top of the retaining member 132 is preferably slightly smaller than the cylindrical portion of the spray tip nozzle 500, which causes the retaining member 132 to hold the spray tip nozzle 500 in place once the cylindrical portion of the spray tip nozzle 500 is pushed into the substantially hollow interior portion of the retaining member 132. The wire brush 330 is installed in the brush holder 140 by pressing a portion of the handle into the brush holder 140, causing the brush holder 140 to hold the wire brush 330 in place. With the configuration shown in FIGS. 1, 2 and 6, the sprayer accessory holder 100 can hold two tip housings and four spray tip nozzles. However, this configuration is shown by way of example. A sprayer accessory holder in accordance with the disclosure and claims herein can include any suitable number of retaining members for tip housings and any suitable number of retaining members for spray tip nozzles. In addition, the brush holder 140 is optional, and could be omitted in some configurations.

FIG. 7 is an enlarged view that shows suitable preferred dimensions for the retaining members 120 and 122 that receive a tip housing. The frustoconical member has a bottom width of 0.875 in (22 mm), has a top width of 0.75 in (19 mm), a height of 0.625 in (16 mm), and side wall thickness of 0.1875 in (4.8 mm). Typical tip housings in common use in the United States have 0.875 in (22 mm) coarse internal threads. With the dimensions shown in FIG. 4 for a resilient material, a tip housing can be pushed onto the retaining member and given a clockwise twist, which results in the internal threads on the tip housing engaging the resilient material on the exterior surface of the retaining member, thereby holding the tip housing in place on the retaining member. In addition, since the retaining members 120 and 122 retain a tip housing by the internal threads on the tip housing engaging the external portion of the retaining member, the interior portion of the retaining members 120 and 122 need not be substantially hollow 410, but could be solid.

FIG. 8 shows suitable preferred dimensions for the retaining members 130, 132, 134 and 136 that receive spray tip nozzles. The frustoconical member preferably has a bottom width of 0.75 in (19 mm), a top width of 0.625 in (16 mm), a height of 0.75 in (19 mm), and a substantially hollow interior 510 with side wall thickness of 0.125 in (3.2 mm). Typical spray tip nozzles in common use in the United States have an outer cylindrical body that has a diameter of 0.435 in (11 mm). With the dimensions shown in FIG. 8 for a resilient material, a spray tip nozzle as shown in FIG. 5 can be pushed into the substantially hollow interior portion 510, which results in holding the spray tip nozzle in place in the retaining member. One can visualize pushing a spray tip nozzle 500 as shown in FIG. 5 into the retaining member shown in FIG. 8. Because the tip of the spray tip nozzle is 0.375 in (9.5 mm) and the opening is the same size 0.375 in (9.5 mm), as the spray tip nozzle 500 is pushed down into the retaining member in FIG. 8, the bevel at the tip of the spray tip nozzle causes the resilient material in the retaining member to spread to receive the substantially cylindrical body of the spray tip nozzle, which is preferably 0.435 in (11 mm). Because the cylindrical body of the spray tip nozzle has a greater diameter than the opening of the retaining member, the result is the retaining member spreading to receive the spray tip nozzle, and because the retaining member is made of a resilient material, and difference in the diameter of the opening of the retaining member and the diameter of the substantially cylindrical portion of the spray tip nozzle 500 causes the retaining member to hold the spray tip nozzle 500 in place. While preferred dimensions are shown in FIGS. 7 and 8 for the first embodiment, the disclosure and claims herein extend to any suitable dimensions for the retaining members.

In the most preferred embodiment, the base plate, frustoconical retaining members, and brush holder are all monothically molded from the same material. The most preferred material is material that is resilient, such as a natural or synthetic rubber-based material. One suitable resilient material is sold under the trademark Santoprene, which is a thermoplastic vulcanizate. Santoprene is a registered trademark of Exxon Mobile Corporation. Santoprene is fully dynamically vulcanized ethylene propylene diene monomer (EPDM) rubber in a thermoplastic matrix of polypropylene. It looks, feels and behaves like rubber but, due to the polypropylene content, offers simple, flexible part design and manufacturing. Other thermoplastic vulcanizates (TPVs) can be used. In addition, various plastics and other materials, both naturally occurring and synthetic, can be used. Of course, materials that are more resilient or less resilient could also be used within the scope of the disclosure and claims herein. In the most preferred implementation, the material preferably has a Shore A durometer rating of 50-95 (also expressed as 50 A-95 A), more preferably has a Shore A durometer rating of 70-90 (also expressed as 70 A-90 A), and most preferably has a Shore A durometer rating of 85 (or 85 A).

In an alternative embodiment, various components of the sprayer accessory holder could be manufactured separately, then assembled. For example, the frustoconical members could have a configuration shown at 900 in FIG. 9, with a bottom 910 with a hole through which a screw 920 or other suitable fastener can pass to attach the retaining member 900 to the base plate. Similarly, the brush holder could be a separate piece that is fastened via screw or other fastener to the base plate.

In one embodiment, the retaining members that hold the tip housings could have a smooth exterior surface, as shown in FIGS. 1, 2 and 6-8. In alternative configurations, the retaining members that hold the tip housing could have a textured exterior surface that helps to retain the tip housing in place. Examples of suitable textures are shown in FIGS. 10-12. FIG. 10 shows an external surface with external threads. These external threads could match, for example, the internal threads on a tip housing. The configuration shown in FIG. 10 could be used when the frustoconical members are made of a more rigid material, such as molded plastic. FIG. 11 shows an external surface with ribs. These ribs help retain a tip housing in place. The tip housing can be pushed down so the internal threads pass over or engage the ribs, or can be twisted so the internal threads engage the ribs. FIG. 12 shows an external surface with bumps. These bumps could be in a uniform geometric pattern, or could be more randomly placed, as shown in FIG. 12. The tip housing can be pushed down so the internal threads pass over or engage one or more of the bumps, or can be twisted so the internal threads engage one or more of the bumps. Of course, many other textures could be used, all of which are within the scope of the disclosure and claims herein.

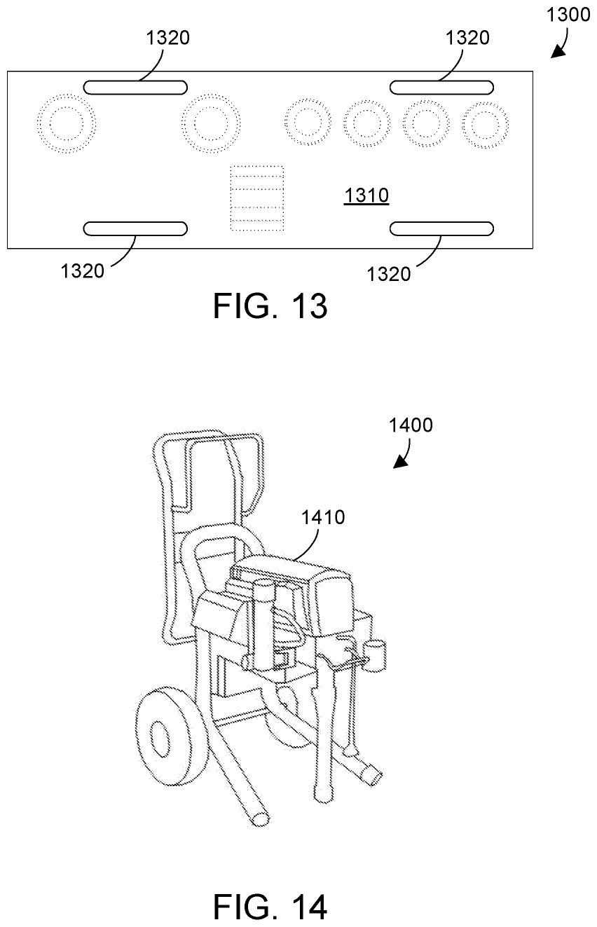

FIG. 13 shows a sprayer accessory holder 1300 that is similar in many respects to the sprayer accessory holder shown in FIGS. 1, 2 and 6, with the addition of a plurality of slots 1320 on the base plate 1310. These slots allow the sprayer accessory holder 1300 to be attached to an airless sprayer using one or more straps. With the configuration shown in FIG. 13, two straps would pass through each pair of slots 1320 to attach the sprayer accessory holder 1300 to an airless sprayer. Note that any suitable number of slots could be included for any suitable number of straps.

The sprayer accessory holder disclosed herein can be a separate piece that is attached to an airless sprayer. The configuration in FIGS. 1, 2 and 6 could be attached to the upper cover 1410 of an airless sprayer 1400 shown in FIG. 14. In one suitable example, double-stick foam tape could be attached to the bottom of the base plate 110, which is then attached to the upper cover 1410 of the airless sprayer. Instead of double-stick foam tape, one or more adhesive hook-and-loop strips could be used. In another example, the upper cover 1410 could include threaded inserts that align with corresponding holes in the base plate, allowing screws to pass through the base plate of the sprayer accessory holder into the threaded inserts, thereby attaching the sprayer accessory holder to the upper cover 1410. In yet another example, a replacement piece for the upper cover 1410 could be fabricated with an integral sprayer accessory holder. This would allow a person to remove the existing upper cover 1410 and retrofit the sprayer with a replacement upper cover that includes the sprayer accessory holder. In another example, an airless sprayer 1400 could be fabricated at the factory with the sprayer accessory holder as an integral part of the upper cover 1410. While the discussion above relates to the upper cover 1410 of an airless sprayer 1400, the sprayer accessory holder could be attached or located at any suitable location on the airless sprayer, whether on the enclosure of the airless sprayer, the frame of the airless sprayer, or the handle of the airless sprayer.

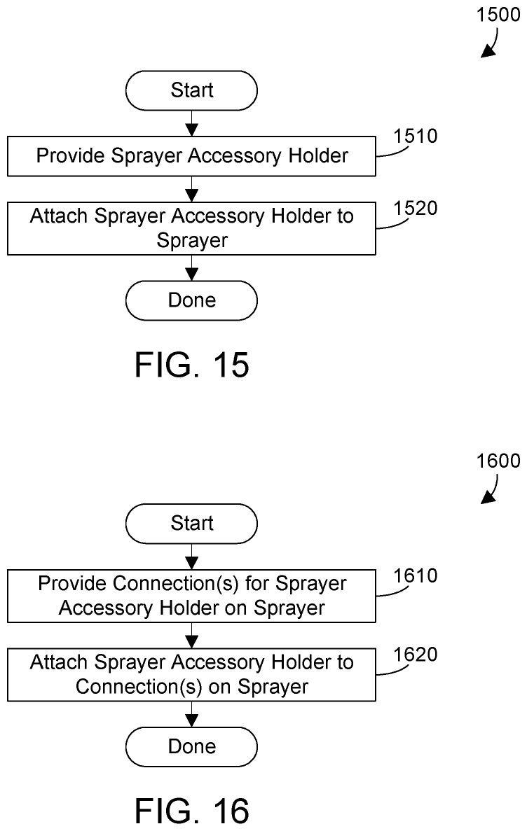

FIGS. 15-18 disclose different methods for providing a sprayer accessory holder that are all within the scope of the disclosure and claims herein. Referring to FIG. 15, a separate sprayer accessory holder is provided (step 1510). The sprayer accessory holder is then attached to the sprayer (step 1520). Method 1500 is then done. The attachment in step 1520 can be in any suitable way, including straps, adhesive, adhesive tape, hook-and-loop fasteners, rivets, screws, etc.

Referring to FIG. 16, a method 1600 begins by providing connections for a sprayer accessory holder on a sprayer (step 1610). Any suitable connections could be used, including threaded holes for receiving screws, smooth holes for receiving rivets, posts that pass through corresponding holes in the base plate of the sprayer accessory holder and are secured by pins that pass through small holes in the posts, straps with buckles, etc. The sprayer accessory holder is then attached to the connection(s) on the sprayer (step 1620). Method 1600 is then done.

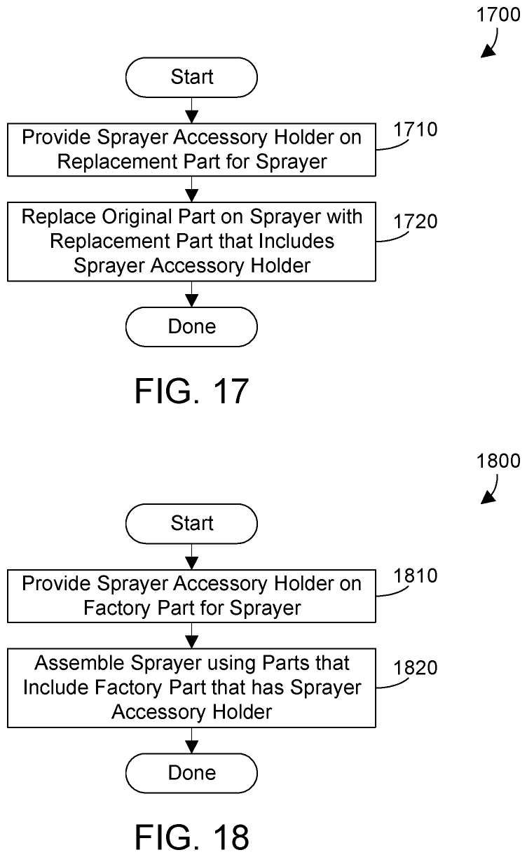

Referring to FIG. 17, a method 1700 begins by providing a sprayer accessory holder on a replacement part for the sprayer (step 1710). The original part on the sprayer is then replaced with a replacement part that includes the sprayer accessory holder (step 1720). Method 1700 is then done. Method 1700 allows retrofitting an existing sprayer to include an integral sprayer accessory holder.

Referring to FIG. 18, a method 1800 begins by providing a sprayer accessory holder on a factory part for the sprayer (step 1810). The sprayer is then assembled using parts that include the factory part that has the sprayer accessory holder (step 1820). Method 1800 is then done. In this manner a new sprayer can be manufactured at the factory with an integral sprayer accessory holder.

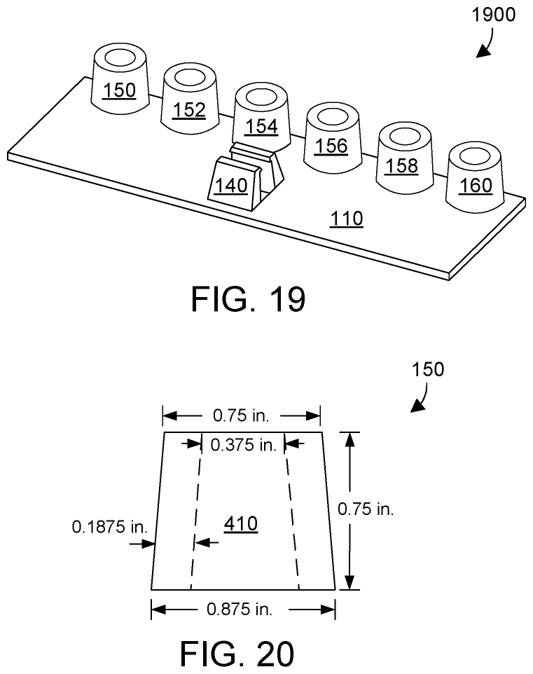

The first embodiment shown in FIGS. 1, 2 and 6 include two different sizes of frustoconical retaining members, a first size (e.g., 120, 122) to hold a tip housing and a second size (e.g., 130, 132, 134 and 136) to hold a spray tip nozzle. Note that the external portion of the retaining members 120 and 122 is dimensioned to engage the internal threads on a tip housing, while the retaining members 130, 132, 134 and 136 have a substantially hollow portion and an opening dimensioned to receive and hold in place spray tip nozzles. In a second embodiment of the sprayer accessory holder 1900 shown in FIG. 19, a plurality of frustoconical retaining members 150, 152, 154, 156, 158 and 160 are all the same size, and have external dimensions to hold a tip housing, and are substantially hollow with internal dimensions to hold a spray tip nozzle. Each of these retaining members can thus be used to hold either a tip housing or a spray tip nozzle at the user's discretion. One suitable configuration for the retaining members 150, 152, 154, 156, 158 and 160 in FIG. 19 is shown in retaining member 150 in FIG. 20. The base diameter of the retaining member 150 is preferably 0.875 in (22 mm), the top diameter is preferably 0.75 in (19 mm), and the height is preferably 0.75 in (19 mm). The retaining member 150 includes a substantially hollow portion 410 with side walls that preferably have a thickness of 0.1875 in (4.8 mm), which produces an opening of 0.375 in (9.5 mm). The sprayer accessory holder 1900 allows a user to put either a tip housing onto each retaining member or to put a sprayer tip nozzle into the retaining member.

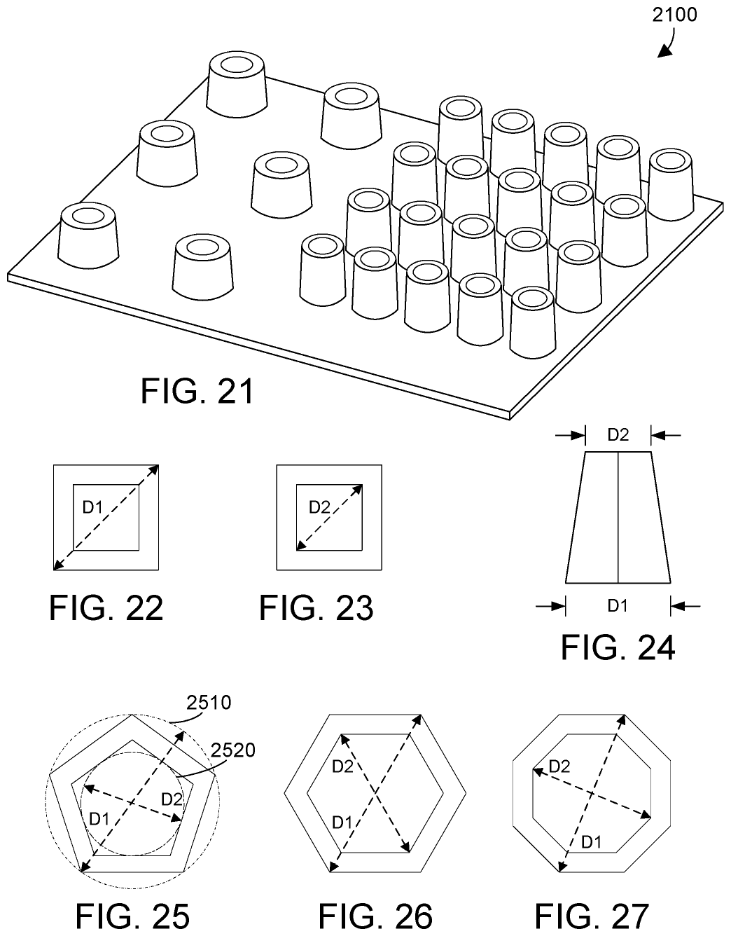

A third embodiment for a sprayer accessory holder is shown at 2100 in FIG. 21. The sprayer accessory holder 2100 includes a larger number of retaining members, and would be suitable, for example, for placement in a van or truck or on a wall at a painter's place of business.

While frustoconical members are shown in the three preferred embodiments shown in FIGS. 1, 19 and 21 as the preferred implementation, retaining members could be made in any suitable size and shape, so long as retaining members designed to hold tip housings have certain minimum and maximum dimensions, and so long as retaining members designed to hold spray tip nozzles have a substantially hollow interior and an opening that will receive and hold a spray tip nozzle. Various configuration are shown in FIGS. 22-32 to illustrate some example configurations for a retaining member that holds tip housings. FIGS. 22-24 show a truncated pyramid-type structure, where the base has a first dimension D1 and the top has a second dimension D2 that is smaller than D1. So long as the second dimension D2 is smaller than the threaded opening of the spray tip nozzle, and the first dimension D1 is greater than the threaded opening of the spray tip nozzle, the spray tip nozzle can be placed on the retaining member shown in FIGS. 22-24, then twisted so the threads of the tip housing engage the edges of the retaining member.

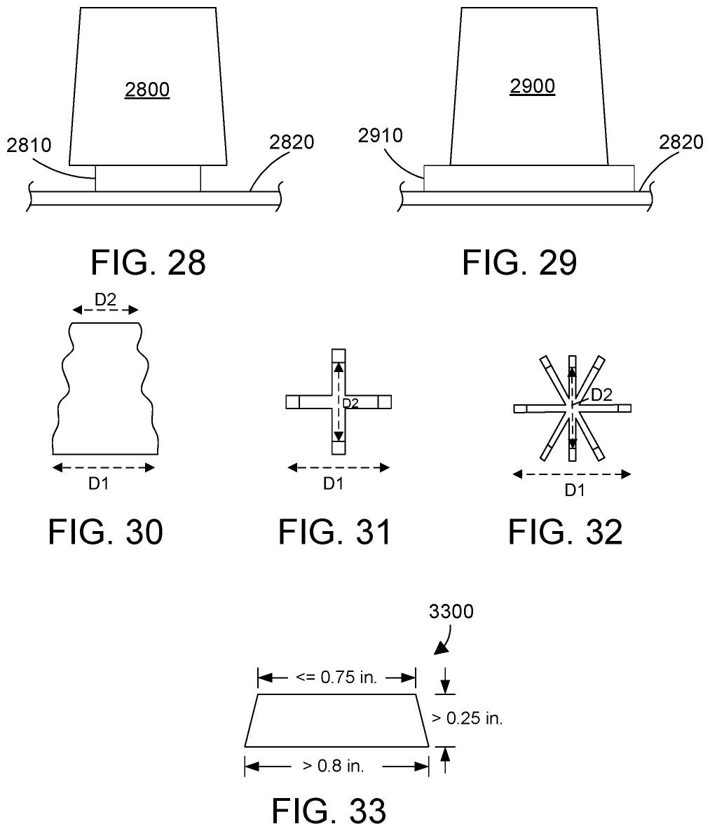

For a retaining member that holds a tip housing, any suitable external configuration can be used. Top views of three possible configurations are shown in FIGS. 25-27. A truncated tapered pentagonal structure could be used, as shown in FIG. 25, with larger dimension D1 that extends from a point on the base pentagon to a point opposite on a circle 2510 that connects all exterior points of the pentagon, and smaller dimension D2 that extends across the diameter of a circle 2520 that touches all sides of the pentagon. A truncated tapered hexagonal structure could be used, as shown in FIG. 26, with larger dimension D1 and smaller dimension D2. A truncated tapered octagonal structure could be used, as shown in FIG. 27, with larger dimension D1 and smaller dimension D2. In addition, a retaining member could have a base that is larger or smaller than the larger dimension D1, as shown in the side views in FIGS. 28 and 29. FIG. 28 shows a retaining member 2800 that includes a base 2810 fixedly attached to the base plate 2820. The base 2810 has a dimension smaller than the larger dimension D1. FIG. 29 shows a retaining member 2900 that includes a base 2910 fixedly attached to the base plate 2820. The base 2910 has a dimension larger than the larger dimension D1. In addition, while several of the specific configurations for retaining members discussed herein include linear tapers between the larger dimension D1 and the smaller dimension D2, any suitable nonlinear taper could be used, as shown by way of example in the side view in FIG. 30. In addition, while several of the specific configurations for retaining members discussed herein include external surfaces of uniform dimensions in any given horizontal plane, alternative configurations could include nonuniform dimensions. For example, the top view of retaining members in FIGS. 31 and 32 show two configurations where the retaining member comprises multiple members that extend from a central point.

A retaining member that is designed to hold a tip housing most preferably includes a lower portion having a first dimension D1 and an upper portion having a second dimension D2 less than D1. This configuration allows a tip housing to be installed on the retaining member by placing the threaded end of the tip housing onto the retaining member and either pushing the tip housing or rotating the tip housing until the tip housing engages the retaining member so the tip housing is held in place. One suitable side view of a retaining member 3300 that is designed to hold a tip housing is shown in FIG. 33. Retaining member 3300 preferably includes a larger dimension (such as D1 in FIGS. 22-27 and FIGS. 30-32) that is greater than 0.8 in (20 mm), a smaller dimension (such as D2 in FIGS. 22-27 and FIGS. 20-32) that is less than or equal to 0.75 in (19 mm), and a height that is greater than 0.25 in (6.4 mm). Suitable examples of a retaining member designed to hold a tip housing that has dimensions that are within the preferred dimensions in FIG. 33 are shown in FIGS. 7 and 20. The height for a retaining member designed to hold a tip housing is preferably greater than 0.25 in (6.4 mm) and less than 2.0 in (51 mm), is more preferably from 0.4 in (10 mm) to 1.0 in (25 mm), and is most preferably from 0.625 in (16 mm) to 0.75 in (19 mm). The larger dimension D1 is preferably greater than 0.8 in (20 mm) and less than 1.2 in (30.5 mm), is more preferably 0.85 in (21.6 mm) to 1.0 in (25 mm), and is most preferably 0.875 in (22 mm). The smaller dimension D2 is preferably from 0.25 in (6.4 mm) to 0.75 in (19 mm), is more preferably 0.5 in (12.7 mm) to 0.75 in (19 mm), and is most preferably 0.75 in (19 mm). Note the interior structure of the retaining member 3300 could be substantially hollow, partially hollow, or solid. The interior structure of retaining member 3300 is unimportant when the retaining member 3300 will always be used for tip housings.

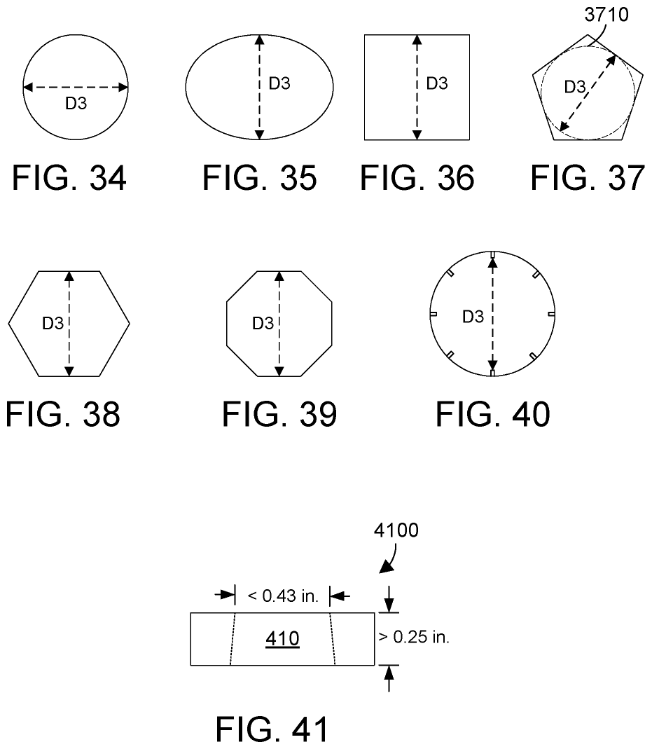

A retaining member that is designed to hold a spray tip nozzle most preferably includes a substantially hollow interior portion with an opening dimensioned to receive and hold the substantially cylindrical body of a spray tip nozzle. The opening can have any suitable shape or configuration as long as one dimension is less than a specified value. For the examples in FIGS. 34-40, the dimension D3 is the dimension that must be less than or equal to a specified value in order for the retaining member to receive and hold in place a spray tip nozzle. FIG. 34 shows a circular configuration for the opening of the substantially hollow portion. FIG. 35 shows an oval configuration for the opening of the substantially hollow portion. FIG. 36 shows a square configuration for the opening of the substantially hollow portion. FIG. 37 shows a pentagon configuration for the opening of the substantially hollow portion. FIG. 38 shows a hexagon configuration for the opening of the substantially hollow portion. FIG. 39 shows an octagon configuration for the opening of the substantially hollow portion. FIG. 40 shows a configuration for the opening of the substantially hollow portion that includes a plurality of retaining fingers. In each case, dimension D3 is selected to be less than the diameter of the substantially cylindrical body of a spray tip nozzle so the retaining member can receive and hold the spray tip nozzle in place. Note the configurations shown in FIGS. 34-40 are shown by way of example, and are not limiting. The disclosure and claims herein expressly extend to any suitable configuration for an opening that has a dimension less than a specified value.

One suitable side view of a retaining member 4100 that is designed to hold a spray tip nozzle is shown in FIG. 41. Retaining member 4100 preferably includes a substantially hollow portion 410 and an opening that is preferably less than 0.43 in (11 mm). The height of the retaining member 3400 is preferably greater than 0.25 in (6.4 mm). Suitable examples of a retaining member designed to hold a tip housing that has dimensions that are within the preferred dimensions in FIG. 41 are shown in FIGS. 8 and 20. The height for a retaining member designed to hold a spray tip nozzle is preferably greater than 0.25 in (6.4 mm) and less than 2.0 in (51 mm), is more preferably from 0.4 in (10 mm) to 1.0 in (25 mm), and is most preferably from 0.625 in (16 mm) to 0.75 in (19 mm). The opening has a dimension (such as D3 shown in FIGS. 34-40) that is preferably less than 0.43 in (11 mm), more preferably less than 0.4 in (10 mm), and most preferably 0.375 in (9.5 mm) or less. The side walls of the substantially hollow interior portion 410 can be tapered as shown in FIG. 41, or could be vertical. Note the exterior structure of the retaining member 4100 could have any suitable size and shape. The exterior configuration of retaining member 4100 is unimportant when the retaining member 4100 will only be used for spray tip nozzles.

Note the two configurations shown in FIGS. 33 and 41 could be combined to provide a single retaining member that has an external configuration shown in FIG. 33 onto which a tip housing may be placed and an internal configuration shown in FIG. 41 into which a spray tip nozzle may be placed. Such a retaining member could be used for holding a tip housing or a spray tip nozzle at the user's discretion.

The sprayer accessory holder allows a painter to be much more efficient by storing tip housings and spray tip nozzles directly on the airless sprayer. The painter need not stop painting and search in a toolbox or other location for a different tip housing or spray tip nozzle. The sprayer accessory holder stores tip housings, spray tip nozzles, and a wire brush in a way that these items can be easily accessed when needed, and further provides a convenient place to store a tip housing or a spray tip nozzle when removed from a spray gun.

A sprayer accessory holder provides a place to put multiple tip housings and multiple spray tip nozzles. The sprayer accessory holder can be a separate piece that is attached to an airless sprayer, can be part of a replacement part for an airless sprayer, or can be part of a new part on an airless sprayer. The sprayer accessory holder preferably includes a plurality of frustoconical members, one or more of which is dimensioned to receive a tip housing and one or more of which is dimensioned to receive a spray tip nozzle. In one suitable embodiment, each retaining member has external dimensions for receiving a tip housing and a substantially hollow interior with an opening dimensioned to receive a spray tip nozzle. This allows a user to use any retaining member to hold a tip housing or to hold a spray tip nozzle, at the user's discretion. The sprayer accessory holder can optionally include a holder for a wire brush. The sprayer accessory holder provides a place to store and access tip housings and spray tip nozzles on the airless sprayer, thereby eliminating the need to retrieve these parts from a toolbox or to return these parts to a toolbox.

While the sprayer accessory holder has been described herein in the context of airless sprayers, the sprayer accessory holder could be adapted and used to hold nozzle tips for a variety of different types of sprayers, including water sprayers, chemical sprayers, etc.

The disclosure and claims herein support a sprayer accessory holder comprising: a base plate; a first frustoconical retaining member fixedly coupled to the base plate and having a first base diameter; and a second frustoconical retaining member fixedly coupled to the base plate and having a second base diameter less than the first base diameter.

The disclosure and claims herein further support a sprayer accessory holder comprising: a base plate; a plurality of first frustoconical retaining members, each having a first base diameter, a first substantially hollow interior, and an external surface dimensioned to engage internal threads on a tip housing for a sprayer; a plurality of second frustoconical retaining members, each having a second base diameter less than the first base diameter and having a second substantially hollow interior dimensioned to receive a portion of a substantially cylindrical body of a spray tip nozzle; a brush holder; wherein the base plate, the plurality of first frustoconical retaining members, the plurality of second frustoconical retaining members, and the brush holder are monothically molded from a thermoplastic vulcanizate that has a Shore A durometer rating in a range of 70-90.

The disclosure and claims herein additionally support a method for providing a sprayer accessory holder on a sprayer, the method comprising: (A) providing a sprayer accessory holder comprising: a base plate; a first frustoconical retaining member fixedly coupled to the base plate and having a first base diameter; and a second frustoconical retaining member fixedly coupled to the base plate and having a second base diameter less than the first base diameter; and (B) attaching the sprayer accessory holder to the sprayer.

One skilled in the art will appreciate that many variations are possible within the scope of the claims. Thus, while the disclosure is particularly shown and described above, it will be understood by those skilled in the art that these and other changes in form and details may be made therein without departing from the spirit and scope of the claims.

1. A sprayer accessory holder comprising:
a base plate having a substantially planar bottom surface;
a first frustoconical retaining member fixedly coupled to a top surface of the base plate and having a first base diameter; and
a second frustoconical retaining member fixedly coupled to the top surface of the base plate and having a second base diameter less than the first base diameter.

2. The sprayer accessory holder of claim 1 wherein the second frustoconical retaining member comprises a substantially hollow interior.

3. The sprayer accessory holder of claim 1 further comprising a brush holder fixedly coupled to the base plate.

4. The sprayer accessory holder of claim 3 wherein the brush holder is dimensioned to receive and hold a portion of a wire brush.

5-6. (canceled)

7. The sprayer accessory holder of claim 1 wherein an external surface of the first frustoconical retaining member is dimensioned to engage internal threads on a tip housing for a sprayer.

8. The sprayer accessory holder of claim 2 wherein the substantially hollow interior of the second frustoconical retaining member is dimensioned to receive a portion of a substantially cylindrical body of a spray tip nozzle.

9. The sprayer accessory holder of claim 1 wherein the base plate, first frustoconical retaining member and second frustoconical retaining member are monolithically molded from a resilient material.

10. The sprayer accessory holder of claim 9 wherein the resilient material comprises a thermoplastic vulcanizate.

11. The sprayer accessory holder of claim 9 wherein the thermoplastic vulcanizate has a Shore A durometer rating of 70-90.

12. The sprayer accessory holder of claim 1 wherein an exterior surface of the first retaining member comprises threads.

13. The sprayer accessory holder of claim 1 wherein an exterior surface of the first retaining member comprises a plurality of ridges.

14. The sprayer accessory holder of claim 1 wherein an exterior surface of the first retaining member comprises a plurality of bumps.

15. The sprayer accessory holder of claim 1 wherein the base plate comprises a plurality of slots that allow attaching the base plate to a sprayer using at least one strap.

16. The sprayer accessory holder of claim 1 wherein the first frustoconical retaining member comprises a textured exterior surface.

17. A sprayer accessory holder comprising:
a base plate;
a plurality of first frustoconical retaining members, each having a first base diameter, a first substantially hollow interior, and an external surface dimensioned to engage internal threads on a tip housing for a sprayer;
a plurality of second frustoconical retaining members, each having a second base diameter less than the first base diameter and having a second substantially hollow interior dimensioned to receive a portion of a substantially cylindrical body of a spray tip nozzle;
a brush holder on a same side of the base plate as the plurality of first frustoconical retaining members and the plurality of second frustoconical retaining members;
wherein the base plate, the plurality of first frustoconical retaining members, the plurality of second frustoconical retaining members, and the brush holder are monolithically molded from a thermoplastic vulcanizate that has a Shore A durometer rating in a range of 70-90.

18-20. (canceled)

21. An airless sprayer comprising:
a sprayer accessory holder fixedly attached to the airless sprayer, the sprayer accessory holder comprising:
a base plate;
a first frustoconical retaining member fixedly coupled to a top surface of the base plate and having a first base diameter; and
a second frustoconical retaining member fixedly coupled to the top surface of the base plate and having a second base diameter less than the first base diameter.

22. The airless sprayer of claim 21 wherein the sprayer accessory holder comprises a replacement part for the airless sprayer that allows the airless sprayer to be retrofitted with the sprayer accessory holder.

23. The sprayer accessory holder of claim 3 wherein the brush holder is on a same side of the base plate as the first frustoconical retaining member and the second frustoconical retaining member.

24. The sprayer accessory holder of claim 3 wherein the brush holder is on the top surface of the base plate.
